(19) United States
(12) Patent Application Publication
(10) Pub. No.: US 2003/0226579 A1
(43) Pub. Date: Dec. 11, 2003

(54) Serrated doctor blades

(76) Inventor: Gordon Eugene Carrier, East Waterboro, ME (US)

Correspondence Address: BRIANA O'REGAN, SAPPI FINE PAPER N.A., 225 FRANKLIN STREET, BOSTON, MA, 02110, US

(21) Appl. No.: 10/164,154

(22) Filed: Jun. 6, 2002

(51) Int. Cl. B08B 1/00

(52) U.S. Cl. 134/6; 15/256.51; 15/236.01; 15/236.08

(57) ABSTRACT

A doctor blade is provided that is suitable for use in the manufacture of paper, particularly for use in calenders. The doctor blade includes a plurality of serrations in the leading edge.

### BACKGROUND OF THE INVENTION

The present invention relates to serrated doctor blades. More particularly, the present invention relates to serrated doctor blades for use in papermaking, for example in calenders during the manufacture of paper. The term “calender” and variations thereof, as used herein, is intended to refer to an apparatus used to calender paper, including stand-alone calendering units such as supercalenders and calendering units within a papermachine such as machine calenders, gloss calenders and soft nip calenders. The present invention further relates to methods of using doctor blades in papermaking.

The term “doctor blade” and variations thereof, as used herein, is intended to refer to an elongated blade used to clean, scrape or otherwise remove undesirable deposits or particles from a surface. The term doctor blade is occasionally used in papermaking and printing industries to refer to a blade or knife used for controlling, e.g., “metering”, the thickness of a coating or ink layer.

Doctor blades are widely used to remove various contaminants, e.g., pulp, paper and coating residue, from the surface of papermachine rolls. FIG. 1 shows a typical papermachine configuration in which a doctor blade 2 is positioned against a surface 16 of a papermachine roll 12, for example a calender roll. Doctor blades typically have a smooth beveled surface 14, with a leading edge 13, as shown in FIG. 1. The angle of the beveled surface is the angle formed between the beveled surface and the back surface of the doctor blade, and the leading edge 13 is the apex of the angle. The machine direction of the papermaking process is generally known in the art as the direction of the paper web as it passes through the papermachine and is indicated by arrow 18 in FIG. 1.

While conventional doctor blades are used to remove contaminants from roll surfaces, they typically are unable to thoroughly clean the roll surface. In many applications, conventional doctor blades are typically applied against the roll surfaces on an intermittent basis but the deposits of contaminants generally form over time. Such deposits are generally resistant to removal by the doctor blade. Deposits on the roll surface may cause excessive and/or uneven wear of the blade or may damage the beveled edge, resulting in a rough or feathered edge. Furthermore, conventional doctor blades are typically overwhelmed during process mishaps or upsets which result in excessive amounts of paper and/or coating adhering to roll surfaces. In such instances, papermachine operators tend to first increase the blade pressure to facilitate deposit removal. For upsets, however, this approach tends to be inefficient and often ineffective. Operators will then generally clean the roll surfaces by hand using abrasive materials such as a 600 grit aluminum oxide cloth or using a steel scraper.

Doctor blades are often used with on-line calenders, which are typically run at relatively high nip pressures and high roll surface temperatures. These operating conditions tend to increase the amount of coating particles and contaminants on the calender roll surface. If the calendering rolls are not doctored on an almost continuous basis, buildup of coating particles and contaminants reach unacceptable levels too quickly, directly affecting the final product properties of the paper, such as paper gloss and paper smoothness. The formation of deposits, however, is unavoidable even when almost continuous doctoring is employed, requiring periodic cleaning of the roll surface either by hand or with a more abrasive doctor blade.

Such cleaning by hand is generally performed during operation so that the entire roll surface may be cleaned as it rotates. Thus, the ability to clean such stubborn deposits with a doctor blade, rather than by hand, is desirable from a safety perspective. Furthermore, because calender rolls tend to have a very smooth surface for paper quality reasons, the abrasive materials used to clean the roll may cause damage to the roll surface.

When a more abrasive doctor blade is used instead of manual cleaning to remove stubborn deposits, a blade change is generally necessary before and after cleaning. The more abrasive blade typically cannot remain in place because it tends to be too abrasive for continuous use. Because blade changes are necessary to prevent damage to the roll surface, production tends to be disrupted. It is desirable to minimize disruptions to production caused by the need to change doctor blades.

There remains a need for a doctor blade that may be used to remove stubborn deposits from roll surfaces during operation. There also remains a need for a doctor blade that can remain in its holder after removal of deposits to minimize production disruptions. Finally, there remains a need for a doctor blade that may be used on an almost continuous basis after the deposits have been removed.

### SUMMARY OF THE INVENTION

The inventor has discovered that a doctor blade that includes a plurality of serrations in the elongated leading edge of the doctor blade effectively removes deposits from the surface of a roll. The term “serrations” and variations thereof, as used herein, means intentional discontinuities in the elongated leading edge of the doctor blade. The term “serrations” includes any type of notch or interruption, having any type of geometry, which interrupts the continuity of the blade edge. Serrations, as used herein, exhibit dimensions having widths equal to or greater than their depths, e.g., a depth to width aspect ratio of about 1:1 to 1:10. The segments of the doctor blade edge between such serrations may be referred to as teeth or projections.

The inventor has found that the serrations tend to wear away as the blade edge wears away during the cleaning process. Consequently, after the deposits have been removed, the doctor blade may be left in place to function as a conventional non-serrated doctor blade. The inventor has also discovered that when the doctor blade is formed from composite material, it may remain in substantially continuous contact with the surface of a roll during operation without unacceptable damage to the surface of the roll.

The doctor blade is suitable for use in the manufacture of paper, polymer film, flooring, and textiles, in printing, and in other processes that use rolls in the manufacture of web products, i.e., products formed in a continuous length and typically wound into rolls. Embodiments of the doctor blade thoroughly clean roll surfaces without unacceptable deterioration of the roll surfaces and exhibit the structural properties required for effectual doctoring, such as stiffness in both axes of the doctor blade. The doctor blades also tend to wear uniformly. Embodiments of the doctor blade may continue to be used after the serrations have worn away.

In one aspect, the invention features a doctor blade which includes a body having an elongated edge defining a plurality of serrations.

Preferred embodiments may include one or more of the following features. The body includes a beveled surface. The serrations have a hemispherical shape. The serrations have a depth of about 1.50 to 8.50 mm. The depth of the serrations does not exceed 25% of the width of the doctor blade, preferably the depth of the serrations is about 10 to 15% of the doctor blade width. The depth of the serrations is non-uniform along the edge. The width of the serrations is about 6.35 to 14.30 mm. The summation of the widths of the serrations is about 30 to 60%, preferably 40 to 50% of the length of the doctor blade. The spacing of the serrations is about 9.50 to 25.40 mm, as measured from the center of one serration to the center of an adjacent serration. The spacing of the serrations is non-uniform along the edge. The edge further includes a plurality of relief cuts. The relief cuts extend from the bottom surface of at least some of the serrations into the width of the doctor blade.

In another aspect, the invention features a doctor blade which includes a body having an elongated edge defining a plurality of serrations and a plurality of relief cuts each extending from a bottom surface of at least some of the serrations into the width of the doctor blade. The term “relief cut” and variations thereof, as used herein, means a slot or slit exhibiting dimensions having a depth significantly greater than its width, e.g., a depth to width aspect ratio of about 1:0.0625 to 1:0.25.

Preferred embodiments may include one or more of the following features. The relief cuts are formed in alternating serrations. The combined depth of a serration and a relief cut is about 15 to 30% of the width of the doctor blade.

In another aspect, the invention features a doctor blade which includes a body having an elongated edge, the doctor blade including composite material that includes a plurality of fibrous layers, impregnated with a resin, and the edge defining a plurality of serrations.

Preferred embodiments may include one or more of the following features. The body includes a beveled surface. The composite material has a laminate structure including a plurality of unidirectional fibrous layers and a plurality of reinforcement fibrous layers. The impregnating resin is a thermoplastic resin or an epoxy resin, i.e., a resin containing an epoxide, oxirane or ethoxylene group. The resin has a glass transition temperature (Tg) of about 65 to 315° C. The resin further includes an abrasive additive selected from the group consisting of glass microspheres, glass fibers, crushed glass, synthetic or industrial diamond particles, silica particles, silicon carbide particles, boron particles, zirconium particles, aluminum oxide particles and mixtures thereof.

In another aspect, the invention features a method of cleaning a circumferential roll surface including:

a) positioning a doctor blade which includes a body having an elongated serrated edge near the roll surface;

b) pressing the serrated edge of the doctor blade against the roll surface; and

c) simultaneously with the pressing step, oscillating the doctor blade in a direction substantially parallel with the rotational axis of the roll.

Preferred methods may include one or more of the following features. The body includes a beveled surface. The doctor blade includes composite material in a laminate structure of a plurality of fibrous layers impregnated with resin. The serrated edge of the doctor blade is in contact with the rotating roll surface on an intermittent basis. The serrated edge of the doctor blade remains in substantially continuous contact with the rotating roll surface. The serrations of the serrated edge wear away during use, and the method further includes leaving the blade edge in contact with the roll surface after the serrations have worn away.

In another aspect, the invention features a method of cleaning process contaminants, i.e., coatings components or fibers, from a circumferential surface of a papermaking roll including:

a) positioning a doctor blade which includes a body having an elongated serrated edge near the roll surface during a papermaking process; and

b) pressing the serrated edge of the doctor blade against the roll surface.

Preferred methods may include one or more of the following features. The body includes a beveled surface. Simultaneously with the pressing step, the blade is oscillated in a direction substantially parallel with the rotational axis of the roll. The serrated edge of the doctor blade is in contact with the rotating roll surface on an intermittent basis. The serrated edge of the doctor blade remains in substantially continuous contact with the rotating roll surface. The pressing step is performed at a pressure of about 85 to 700 N/m, preferably about 175 to 440 N/m. The doctor blade includes composite material in a laminate structure of a plurality of fibrous layers impregnated with resin. The impregnating resin has a glass transition temperature of about 65 to 315° C. The resin further includes an abrasive additive selected from the group consisting of glass microspheres, glass fibers, crushed glass, synthetic or industrial diamond particles, silica particles, silicon carbide particles, boron particles, zirconium particles, aluminum oxide particles and mixtures thereof. The serrations of the serrated edge wear away during use, and the method further includes leaving the blade edge in contact with the roll surface after the serrations have worn away.

Other features and advantages of the invention will be apparent from the following detailed description, the drawings, and the claims.

### BRIEF DESCRIPTION OF THE DRAWINGS

FIG. 1 is a schematic perspective view showing a doctor blade in contact with a papermaking roll.

FIG. 2A is a schematic perspective view of a doctor blade according to one embodiment of the invention.

FIG. 2B is a schematic perspective view of a doctor blade according to an alternate embodiment of the invention.

FIG. 3 is a schematic perspective view of a doctor blade according to an alternate embodiment of the invention.

FIG. 4 is an exploded perspective view of a doctor blade according to an alternate embodiment of the invention.

FIG. 5 is a schematic side view of a calendering unit showing a method of using a doctor blade embodying the invention.

FIG. 6 is a schematic side view of a dryer can section showing a method of using a doctor blade embodying the invention.

FIG. 7 is a highly enlarged schematic cross-sectional view of an individual serration through its center.

FIG. 8 is a highly enlarged schematic cross-sectional view of an individual serration through its center according to an alternate embodiment of the invention.

### DETAILED DESCRIPTION OF PREFERRED EMBODIMENTS

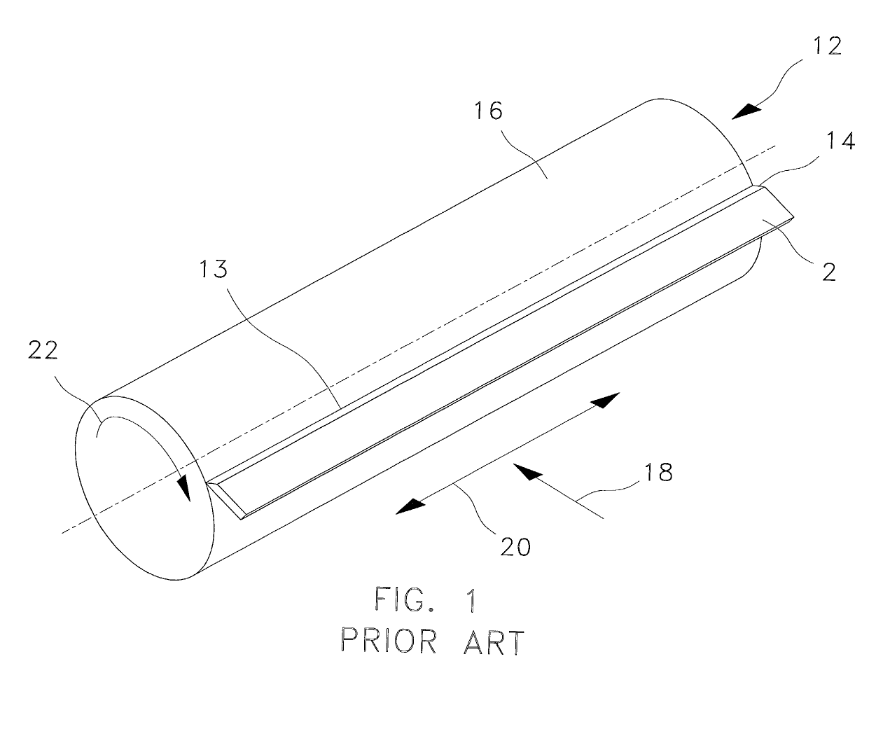

Referring to FIG. 1, a doctor blade 2 is held against a papermaking roll 12, which is rotating about its axis in the direction denoted by arrow 22, such that a leading edge 13 of the doctor blade 2 may remove contaminants from the surface 16 of the roll. In FIG. 1 the machine direction is denoted by arrow 18 and the cross-machine direction is denoted by arrow 20. The doctor blades discussed below would be used in the environment and in the manner depicted in FIG. 1.

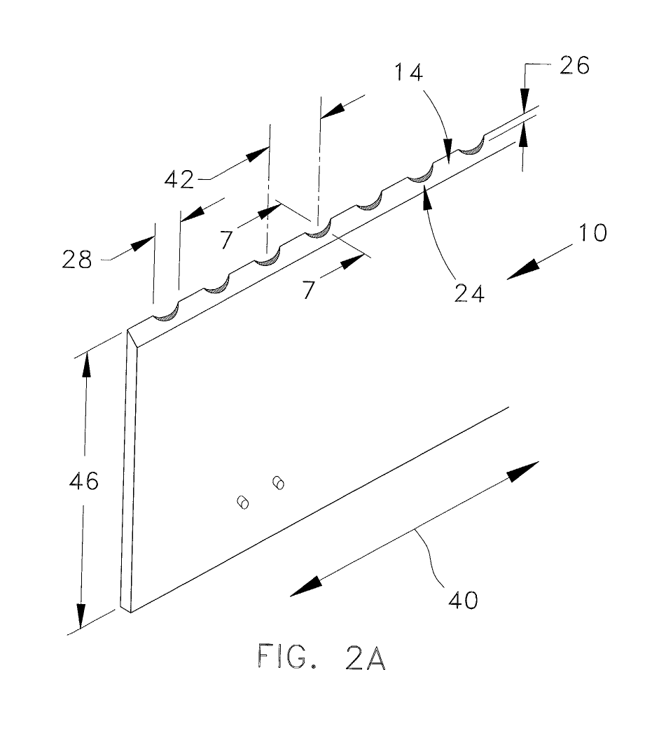

Referring to FIG. 2A, doctor blade 10 of the invention includes containing a plurality of serrations 24 in the leading edge 13, within the beveled surface 14. In FIG. 2A, the serrations 24 exhibit a hemispherical shape but a variety of shapes may be used, e.g., square, rectangular or triangular. As used herein, the term “hemispherical” shall encompass a half-circle shape, as well as arcuate shapes having an area that is greater or less than the area of a half-circle. The serrations 24 provide additional cutting edges to the doctor blade facilitating removal of deposits. Hemispherical serrations are preferred because they tend to exhibit greater resistance to tearing than geometries containing angles. The serrations with angles may be at greater risk for tearing because the angles represent weak points in the serrations. Tearing may occur during handling or during operation from deposits loosened earlier in the process. However, serration geometries with angles may be preferred in some applications, provided that they exhibit sufficient durability. In FIG. 2B, the serrations 24 exhibit a rectangular geometry. The disadvantages of angular geometries may be reduced by rounding the angles, e.g., a rectangular serration with rounded corners.

The serrations 24 are typically of uniform depth 26 and width 28 but serrations of non-uniform depth and/or width may be used as appropriate. Typically the spacing of the serrations is also uniform along the edge of the doctor blade but non-uniform spacing may be desirable in certain situations. For example, certain positions along the length of a roll in a papermachine may exhibit thicker or more adherent deposits of paper, pulp and/or coating, e.g., positions corresponding to the edges of the paper web. In such instances, the serrations on the doctor blade corresponding to such positions may be deeper, wider and/or more numerous to facilitate removal of the deposits. The depth and width of the serrations are also determined by stiffness required in the doctor blade for the particular application.

The depth 26 of the serrations 24 is limited by the width 46 of the doctor blade. Although FIGS. 2A and 2B show serrations within the beveled surface 14, the depth of the serrations may extend past the beveled surface. Typically the maximum depth of the serrations ranges from 10 to 25% of the width 46 of the doctor blade 10. Preferably the maximum depth of the serrations ranges from 10 to 15% of the width 46 of the doctor blade. For papermaking applications, the depth 26 of the serrations typically ranges from 1.50 to 8.50 mm. If the depth of the serrations is greater than about 8.50 mm, the structural integrity, or strength, of the doctor blade may be deleteriously affected. For doctor locations in which mild deposits are expected, e.g., locations where deposits are due primarily to variations in moisture level of the substrate, the depth of the serrations preferably ranges from 1.50 to 4.75 mm. For doctor locations that tend to exhibit significant buildup of deposits, e.g., locations where deposits result from excessive coat weights, the depth of the serrations preferably ranges from 4.75 to 8.50 mm. If the serrations are too shallow, the doctor blade may not be able to adequately clean the roll surface. In addition, the serrations will tend to wear away quickly. In some applications, e.g., where mild deposits are expected and the roll is of a material that is easily damaged, it may be desirable to have the serrations wear away quickly. Thus, serration life can be tailored to a particular application by adjusting serration depth.

The width 28 of the serrations 24 is limited by the length 40 of the doctor blade as well as the depth and spacing of the serrations along the blade length. The total width of the serrations generally ranges from 30 to 60% of the length of the doctor blade to ensure that structural integrity of the blade is maintained. Preferably the total width of the serrations ranges from 40 to 50% of the length of the blade. Most preferably the total width of the serrations is 50% of the length of the blade. Typically the width 28 of an individual serration ranges from 6.35 to 14.30 mm. For mild deposit situations, the width of the serrations preferably ranges from 6.35 to 8.25 mm, while for more severe deposit situations, the width preferably ranges from 8.25 to 14.3 mm. If the serration widths 28 are too narrow for a given situation, the doctor blade tends to be ineffective. If the serrations widths 28 are too wide, the structural integrity of the doctor blade may be reduced.

The spacing of the serrations is measured from the center of one serration to the center of an adjacent serration, as indicated by arrow 42 in FIG. 2A. The spacing of the serrations tends to be determined by the expected characteristics of the deposits in the particular application. In a doctor blade without serrations, the blade pressure tends to be distributed along the entire length of the leading edge. When the leading edge contains serrations, the blade pressure is distributed over the non-serrated portions of the leading edge. Consequently, the blade pressure per unit length of blade increases in the non-serrated portions. Typically the spacing 42 of the serrations ranges from 9.50 to 25.40 mm. For mild deposit situations, the spacing 42 of the serrations tends to be longer for a given serration width, ranging from 19.05 to 25.40 mm, so that the blade pressure is distributed over longer non-serrated sections. For more severe deposit situations, the spacing 42 of the serrations tends to be shorter for a given serration width, ranging from 9.50 to 19.05 mm, so that the blade pressure is concentrated in shorter non-serrated sections.

The dimensions and spacing of the serrations described above are suitable for a composite doctor blade. If other materials are used to construct the doctor blade, the dimensions and spacing of the serrations may vary. If a stronger or stiffer material is used, a greater total width of serrations may be possible, resulting in decreased spacing. Also deeper serrations may be possible with stronger or stiffer doctor blade materials.

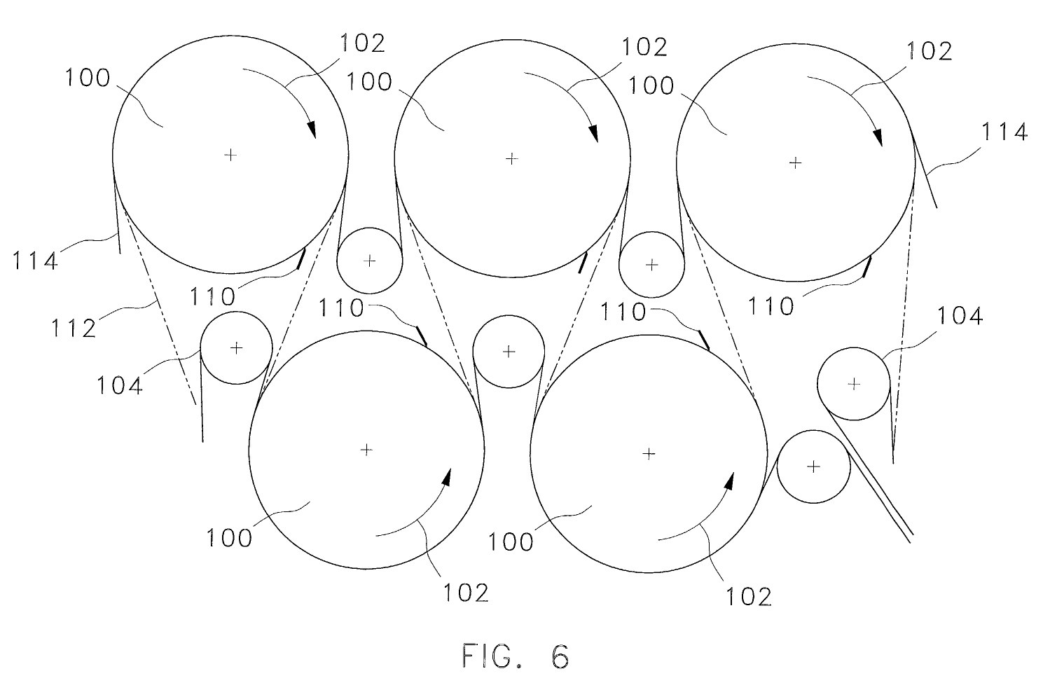

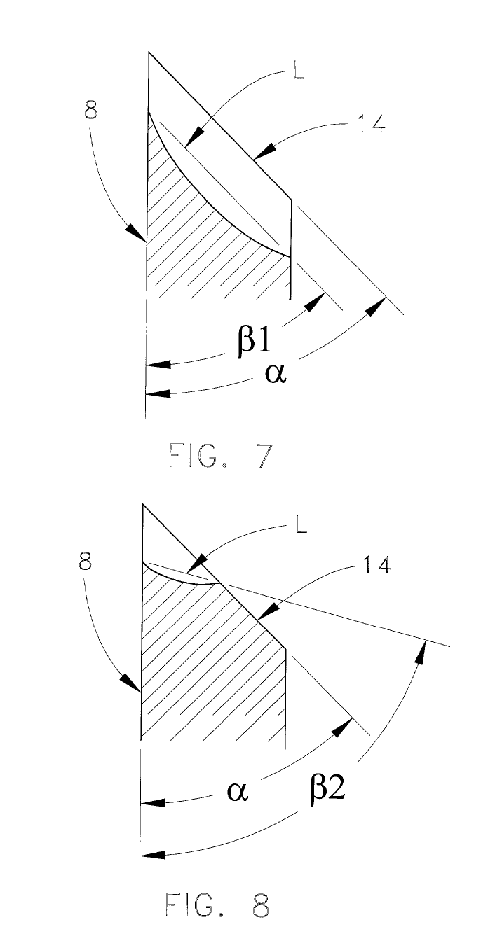

The serrations 24 may be created in the doctor blade before or after the beveled surface 14 is formed. FIG. 7 provides a cross-sectional view of a serration along section line 7-7 in FIG. 2A. FIG. 8 provides the same sectional view as in FIG. 7 but shows a different serration angle. As noted above, the angle of the beveled surface 14, denoted α in FIGS. 7 and 8, is the angle formed between the beveled surface 14 and the back surface 8 of the doctor blade. Referring to FIG. 7, if the serrations are formed before the beveled surface is formed, the final angle of the serrations, denoted β1, tends to exhibit the same angle as the beveled surface. Referring to FIG. 8, if the serrations are formed after the beveled surface is formed, the final angle of the serrations, denoted β2, is adjustable. The angle of the serrations, β, is the angle formed by an imaginary line L drawn across the serration and the back surface 8 of the doctor blade. The angle of the serrations typically ranges from 35° to 90°, preferable 45° to 90°. The hemispherical profile of the serration shown in FIGS. 7 and 8 is generally created by the use of a conical tool bit with the direction of cut parallel to the width 46 of the doctor blade (FIG. 2A). Different serration profiles may be possible with tools bits exhibiting other geometries and/or different cutting directions.

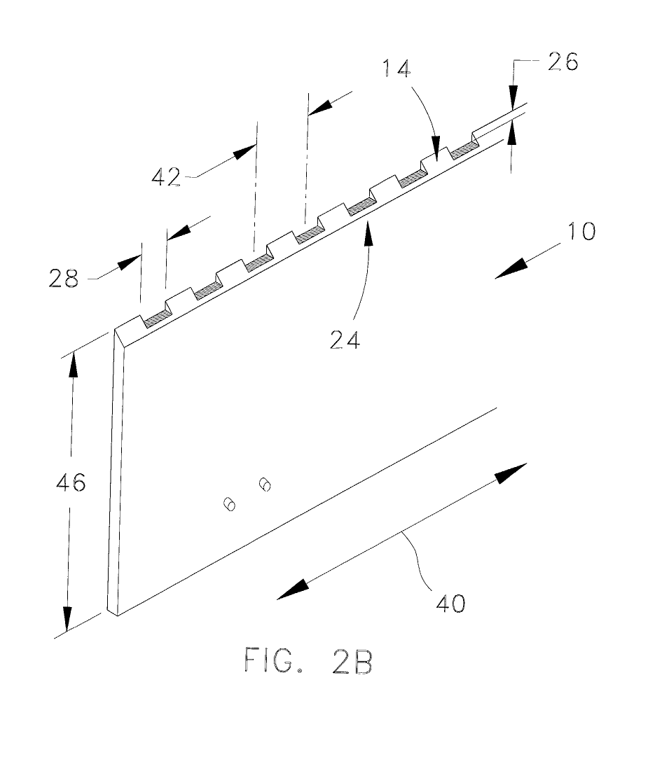

Referring to FIG. 3, an embodiment of doctor blade 10 further includes a plurality of relief cuts 44. A relief cut 44 is formed by creating a notch extending from the bottom surface 45 of a serration 24 into the width 46 of doctor blade 10. Sometimes deposits can form on a roll circumferentially, creating raised bands of material. In such instances, the leading edge 13 of the doctor blade 10 may flex slightly over the bands, lifting the leading edge from the roll surface. As a result, the leading edge may not effectively clean the deposit from the roll surface because the leading edge rides on the surface of the deposit. The relief cuts 44 create localized flexibility in the doctor blade in the longitudinal direction. Consequently, the leading edge 13 of the doctor blade typically conforms more closely to the surface of the bands of deposits allowing the edges of the serrations 24 to cut into the deposits.

The relief cuts 44 are typically of uniform depth 48 and width 47 but relief cuts of non-uniform depth and/or width may be used as appropriate. For instance, certain positions along a roll may exhibit a propensity to form bands of deposits. Serrations in the doctor blade corresponding to such positions may have longer relief cuts to facilitate cleaning. Relief cuts 44 may be formed in all of the serrations 24, or in only some of the serrations as necessary. Preferably relief cuts 44 are formed in alternating serrations. If relief cuts are formed in all serrations, the doctor blade may exhibit excessive flexibility and decreased structural integrity.

The depth 48 of a relief cut is limited by the width 46 of the doctor blade 10 and the width 47 of a relief cut 44 is limited by the width 28 of a serration 24. The depth and width of the relief cuts are also determined by stiffness required in the doctor blade for the particular application. Typically the combined maximum depth of a serration and a relief cut ranges from 15 to 30% of the width 46 of the doctor blade 10. If the combined depth of a serration and a relief cut exceeds about 30% of the blade width, the doctor blade tends to exhibit reduced structural integrity and excessive flexibility, resulting in ineffective cleaning. If the combined depth of a serration and a relief cut is less than about 15% of the blade width, the doctor blade may exhibit insufficient flexibility and tend to ride on the surface of the deposits. For papermaking applications, the combined depth of a serration and a relief cut typically ranges from about 12.5 to 25.5 mm, and the width of a relief cut typically ranges from about 1.5 to 3.2 mm.

The doctor blades 10 may be constructed from metal, e.g., carbon steel, stainless steel, nickel, nickel alloy such as monel, or bronze, metal coated with alloy or ceramic material, plastic, or “composite” materials, i.e., fiber-reinforced polymeric materials.

Metal blades generally exhibit high stiffness in the machine direction, i.e., the direction perpendicular to the rotational axis of the papermachine roll, and good wear characteristics. Metal blades tend to be susceptible to corrosion and may cause unacceptable wear of the roll surface if used in certain positions on the machine. Consequently, metal blades tend to be used in dryer sections of papermachines, particularly Yankee cylinders.

Plastic blades tend to be used in papermachine locations unsuitable for metal blades. Plastic blades tend to have low stiffness and may degrade at the temperatures typically used in the papermaking process. Plastic blades are generally used where the surface of the roll is relatively soft, e.g., a soft rubber covered roll in the press section.

Composite blades are typically formed from a plurality of fibrous layers impregnated with resin, each fibrous layer generally having a woven structure such that a certain proportion of the fibers lay in the machine direction, while the remaining fibers lay in the cross-machine direction, i.e., the direction parallel to the rotational axis of the papermachine roll. The cross-machine direction is generally known in the art as the direction perpendicular to the path of the paper web and is indicated by arrow 20 in FIG. 1.

Although composite blades tend to wear more quickly than metal blades, they also tend to cause less wear on the roll surface. Because composite blades can be tailored to different applications, they are more widely used than metal or plastic blades. Composite doctor blades may be used against a variety of roll surface materials, e.g., cast iron, chilled iron, fabricated steel, chrome plated, Teflon® coated, thermal spray coated, polyurethane, rubber coated, and filled rolls, and in a variety of positions on the papermachine, e.g., dryer cans, calenders, breaker stack, reel drum and size press.

The thickness of a composite doctor blade may range from about 1.40 to 3.20 mm, depending on the location of the doctor blade within the papermaking process and the operating conditions to which it is subjected. Metal doctor blades tend to be thinner than composite doctor blades, ranging from about 0.8 to 1.5 mm, while plastic blades tend to be very thick, e.g., greater than about 6.00 mm. Thinner doctor blades tend to clean the surface of rolls more effectively over the life of the blade. Because the leading edge of a thinner blade is generally thinner than the leading edge of a thick blade, it provides a higher pressure per unit area than the leading edge of a thick blade. Thicker doctor blades tend to have greater mechanical strength and longer blade life. The width of the doctor blade is also dependent on the location of the doctor blade within the papermaking process and the operating conditions to which it is subjected, and may range from about 50 to 125 mm. Practitioners skilled in the art are aware of how to select the appropriate doctor blade thickness and width that balances the desired life of the doctor blade and level of contamination of the roll surface.

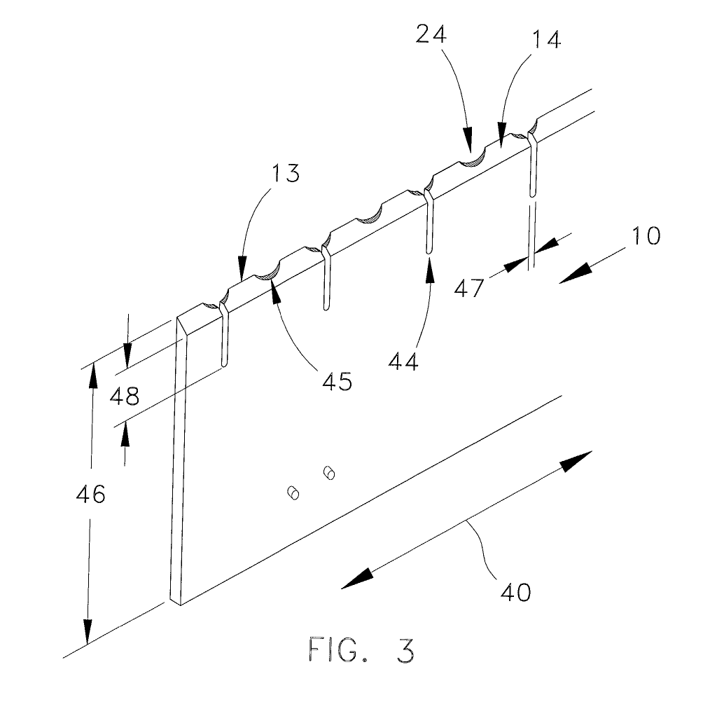

Referring to FIG. 4, a preferred embodiment of doctor blade 10 includes a laminate structure formed from a plurality of unidirectional fibrous layers 32, each layer including a plurality of unidirectional fibers 31, and a plurality of reinforcement fibrous layers 30. The unidirectional layers 32 are arranged within the laminate structure such that the unidirectional fibers 31 are aligned in a direction substantially parallel to the long axis of the doctor blade 10. Reinforcement layers 30 differ from unidirectional fibrous layers 32 in that the majority of the fibers in the reinforcement layers are not oriented parallel to the long axis of the doctor blade 10. Preferably reinforcement layers 30 are included in the laminate structure to provide reinforcement, e.g., stiffness or strength, or to increase the thickness of the doctor blade. Reinforcement layers 30 are shown schematically, without indicating the direction of the fibers, in FIG. 4. Reinforcement layers 30 can have a woven or nonwoven structure and the fibers may be aligned substantially in the machine direction or in two or more directions.

FIG. 4 illustrates an embodiment of the doctor blade that includes nine layers. Typically composite doctor blades will include five to twenty layers but may include more layers depending on the thickness desired for the doctor blade 10. As will be understood by practitioners skilled in the art, the appropriate number of layers for a composite doctor blade is determined by the operating requirements of the particular doctoring application. Each unidirectional layer 32 and reinforcement layer 30 is impregnated with an epoxy or thermoplastic resin such that the layers may be laminated, i.e., bonded under pressure and temperature, together to form a single laminate structure.

As shown in FIG. 4, the laminate structure of one embodiment of the doctor blade 10 may be formed from alternating reinforcement layers 30 and unidirectional layers 32. Preferably the reinforcement layers 30 include fiberglass fibers aligned in two or more directions in a woven structure. The embodiment of the doctor blade 10 shown in FIG. 4 would be suitable for doctoring applications requiring a relatively high level of abrasiveness, such as the calendering of a coated paper web having a relatively high moisture content, e.g., about 4 to 10%, which tends to cause increased build-up of coating particles on the roll surface. The arrangement of the layers within the laminate structure of the doctor blade 10 is generally symmetrical around the central core layer 34, shown as a reinforcement layer 30 in FIG. 4. If the arrangement of the layers is not symmetrical about the central core layer 34, the doctor blade may bend or twist along its long axis.

Suitable fibers for the unidirectional layers 32 include fiberglass, ceramic fibers, and mixtures thereof, preferably fiberglass. As used herein, the term “fiber” is intended to encompass an individual filament or a multifilament strand having a length greater than its width. The unidirectional layers may include relatively short fibrous segments or long continuous fibers, i.e., fibers that run the length of the doctor blade. Preferably, the unidirectional fibrous layers include predominantly long continuous fibers.

Suitable fibers for the unidirectional layers are sufficiently abrasive to materials typically used to form the surface of papermaking rolls, e.g., cast iron, chilled iron, cast steel, or a thermal spray coating including a ceramic or metal matrix material, so that they will clean and/or reduce the roughness of the roll surface. Suitable fibers for the unidirectional fibrous layers are generally sufficiently rigid so as to provide strength in the longitudinal direction to the doctor blade. If the fibers comprising the unidirectional layers are not sufficiently rigid, the flexibility of the doctor blade itself will increase, which may result in ineffectual doctoring of the roll surface because the doctor blade will tend to flex when pressure is applied to clean the roll surface.

The unidirectional fibers are generally provided in the form of a fabric to form the unidirectional layers. Suitable fabrics including unidirectional fibers are generally referred to in the art as “unidirectional fabrics” even though such fabrics may have woven structures such that a certain proportion of the fibers are aligned in a different direction. Suitable unidirectional fabrics contain at least 60% by weight unidirectional fibers. Preferably, the unidirectional fabric includes at least 75% by weight of unidirectional fibers, most preferably 90% by weight.

Unidirectional fabrics preferably have a woven structure, so that the fabric is able to retain its shape through impregnation with resin and the manufacture of the doctor blade. During manufacture of the doctor blade, large sheets of unidirectional layers, and, if desired, reinforcement layers, are impregnated with resin. After impregnation, the impregnated layers are layered so that multiple layers are superimposed on top of one another to form a laminate structure. The laminate structure is then subjected to an elevated temperature and pressure to cure the resin and bond the layers together. The cured laminate structure is then cut into two or more doctor blades, each blade having a long axis.

Suitable unidirectional fabrics including a plurality of unidirectional fibers are available from Fibre Glast Developments Corporation, Brookville, Ohio, e.g., 1093 E-Glass Fabric, and from Saint-Gobain BTI, Inc., Brunswick, Maine, e.g., E-LPb 425 and E-LPb 567 0° Uni-Directional fabrics.

Suitable impregnating resins for the unidirectional layers and the reinforcement layers include a thermoplastic or epoxy resin. Preferably, an epoxy resin system, comprising an epoxy resin and a curing agent, or hardener, is employed. Resins used in the doctor blade are selected to withstand the operating temperatures used in the particular doctoring application. During operation, the resin used to manufacture the doctor blade will be in contact with the surface of the roll. The resin used should not melt and contaminate the roll surface, but should wear away exposing the fibers of the layers. Because the resin is not abrasive, it is preferable that the resin wears away faster than the fibers.

The glass transition temperature, (Tg), of the resin provides an indication of the operating temperatures that the resin will withstand. Resins suitable for use in the doctor blade of the invention have a Tg of about 55 to 315° C., depending on the temperature of the roll surface to be doctored. For high temperature calendering applications, preferred resins are epoxy resins having a Tg ranging from about 65 to 315° C., more preferably about 85 to 315° C. If the Tg of the cured resin is too low for a particular doctoring application, the resin tends to melt and contaminate the surface of the roll. A resin with a high Tg would generally be an unnecessary expense for a doctor blade used against a roll operating at a relatively low temperature.

Suitable epoxy resin systems are commercially available from Fibre Glast Developments Corporation, e.g., the System 2000 Epoxy Resin used with 2020, 2060, or 2120 Epoxy Hardeners, and from Resolution Performance Products, Houston, Texas, e.g., EPON Resin 828 used with EPI-CURE Curing Agent 9552 or EPON Resin 826 used with EPI-CURE Curing Agent W. Alternatively, an epoxy resin such as EPON Resin 828 or EPON Resin 826, available from Resolution Performance Products, may be cured by other curing agents, such as ETHACURE 100 Curative, available from Albemarle Corporation, Baton Rouge, La., or methylene dianiline. Practitioners skilled in the art are aware of how to select an appropriate resin exhibiting a Tg suitable for a particular doctoring application and for ease of use, e.g., the time required to cure and safety precautions.

The doctor blade of the invention includes about 50 to 75% fibrous material by weight, preferably about 60 to 70%, and about 25 to 50% resin by weight, preferably about 30 to 40%. As the percentage of fibrous material in the doctor blade increases, the Tg of the doctor blade tends to increase because the fibrous materials tend to have higher glass transition temperatures than the resins. The doctor blade of the invention should have a Tg of about 75 to 315° C., depending on the temperature of the roll surface to be doctored. For high temperature calendering applications, the Tg of the blade preferably is about 100 to 315° C., more preferably about 150 to 315° C. An increased proportion of fibrous material also tends to increase the abrasiveness of the doctor blade.

Typically, the thickness of each layer prior to bonding into the laminate structure ranges from about 0.20 to 0.50 mm for the unidirectional layers, and from about 0.09 to 0.50 mm for the reinforcement layers. As discussed above, typically the thickness of a composite doctor blade ranges from about 1.50 to 3.20 mm.

The resin used to impregnate the unidirectional or reinforcement layers may include abrasive additives, such as glass microspheres (e.g., hollow or solid), glass fibers, crushed glass, synthetic or industrial diamond particles, silica particles, silicon carbide particles, boron particles, zirconium particles, aluminum oxide particles and mixtures thereof. Preferably the resin includes hollow or solid glass microspheres, more preferably hollow glass microspheres. Preferably all of the fibrous layers of the doctor blade include resin containing glass microspheres. Preferably the amount of glass microspheres used in the resin is at least 5% by weight of glass spheres, more preferably at least 20% by weight. The particle size of suitable glass microspheres is generally limited to less than the thickness of an individual fibrous layer. Preferably, the particle size of glass microspheres is less than about 120 μm, more preferably less than about 75 μm. Suitable hollow glass microspheres are commercially available from Minnesota, Mining and Manufacturing Company, e.g., 3M™ Scotchlite™ Glass Bubbles S32, K46, and S60.

The impregnating resin may also include friction reducing additives, such as carbon particles and powdered polytetrafluoroethylene. Reducing the friction between the doctor blade and the surface of the roll tends to reduce the heat generated during doctoring thereby extending the life of the doctor blade. Such friction reducing additives may be useful when the serrations have worn away and the doctor blade is performing as a non-serrated doctor blade. Practitioners skilled in the art are aware of how to select suitable additives to meet the requirements of a particular doctoring application, e.g., to increase or decrease abrasiveness or reduce friction, and to achieve the desired final product attributes.

The reinforcement layers generally include carbon fibers, aramid fibers, ceramic fibers, fiberglass and mixtures thereof. The reinforcement layers may have a woven or nonwoven structure and the fibers may be aligned substantially in the machine direction or in two or more directions. A woven structure tends to provide a greater level of abrasiveness than a nonwoven structure. The reinforcement layers may be woven in a plain, satin or twill weave style, preferably a plain or satin weave. Preferably, the weight per unit area of the reinforcement layers is about 60 to 350 g/m².

Reinforcement layers comprising carbon fibers are typically used to reduce friction and to increase the strength of the doctor blade in the machine direction. Carbon fibers are characterized by high tensile strength and high stiffness but they are not considered abrasive. Therefore, although the ends of the carbon fibers may act upon the roll surface, they do not tend to form scratches in the roll surface. Aramid fibers may be used to provide tensile strength and abrasion resistance to the doctor blade. Ceramic or fiberglass reinforcement layers provide additional abrasiveness to the doctor blade. In view of the guidance above, practitioners skilled in the art would understand how to select the appropriate composition and number of the reinforcement layers within the laminate structure to meet the requirements of a particular doctoring application, e.g., to reduce friction, to increase stiffness or to increase abrasiveness.

Suitable materials for the reinforcement layers are available from Fibre Glast Developments Corporation, e.g., 241 Woven Fiberglass Fabric, 530 3K Graphite Fabric, and 549 5HS Kevlar® Fabric, and from Saint-Gobain BTI, Inc., e.g., CBX 300 6k Carbon and ARBX 350 Aramid fabrics.

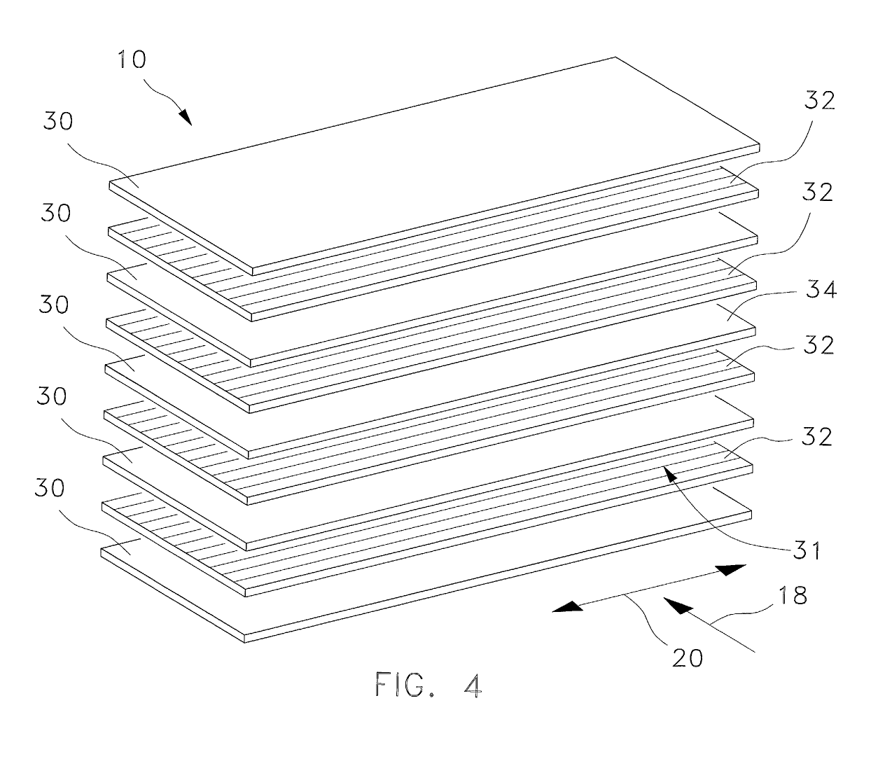

A typical on-line calender is shown in FIG. 5, including two units 50, each unit including two soft rolls 52 and one metal roll 54. The soft rolls 52 are typically comprised of a resilient or yieldable material, such as fiber reinforced epoxy resin. Metal roll 54 may be comprised of cast iron, chilled iron, ductile iron, forged steel or cast steel. Metal roll 54 may be further coated with a thermal spray coating comprising a ceramic or metal matrix material, e.g., a carbide containing metal matrix material. The direction of rotation for each metal roll 54 is denoted by arrow 22. A paper web 60 is passed through the calender units 50, with the aid of guide rolls 62.

Two doctor blades are used, a first doctor blade 56 positioned against the metal roll 54 of the first unit 50, and a second doctor blade 58 positioned against the metal roll 54 of the second unit 50. Generally in on-line calenders, doctor blades are positioned against the roll surface on a substantially continuous basis. The doctor blades 56 and 58 may be located anywhere on the circumference of the metal roll 54, provided that the leading edge 13 (FIG. 1) operates against the rotational direction of the metal roll, as shown in FIG. 5. Preferably, each doctor blade is positioned after the paper web 60 has passed through both nips of each unit 50 formed by the soft rolls 52 and the metal roll 54. Such a location ensures that the doctor blade cleans the metal roll after one full pass of the paper web. Practitioners skilled in the art are aware of the most appropriate location for a doctor blade taking into account unique operational considerations, such as the process path of the paper web and instrumentation or other equipment in the vicinity of the roll to be doctored, safety considerations, and maintenance considerations.

The beveled surface 14 (FIG. 1) is typically cut at a 45° angle, formed between the beveled surface and the horizontal plane formed by the back surface 8 of the doctor blade. The operating angle A (FIG. 5), of the doctor blades 56 and 58 should generally range between about 25 to 30°, measured from the back surface 8 of the doctor blade to a line tangential to the surface of the roll where the leading edge 13 of the doctor blade is positioned. The pressure of the doctor blade against the roll is typically about 85 to 700 N/m, preferably about 175 to 440 N/m.

When a machine upset occurs causing significant deposits on the calender rolls (e.g., too much coating is applied to the paper web and the dryers cannot dry the coating sufficiently), the machine operators advantageously immediately replace the existing doctor blades in the calender section (which may be doctor blades that were initially serrated but which have now worn to an extent that the serrations are non-existent or too shallow for effective cleaning of the deposits) with serrated doctor blades (shown in FIG. 5 as doctor blades 56 and 58). Once the deposits have been removed, the serrated doctor blades 56 and 58 may be applied intermittently to the surface of the metal roll 54 for subsequent cleaning activities. It is generally preferable, however, that the doctor blades 56 and 58 are thereafter applied to the surface of the calender roll on a substantially continuous basis while the roll is in operation, as is conventional in on-line calenders. As discussed above, the serrations wear away as the beveled surface wears away during the cleaning process. Consequently, after the deposits have been removed, the doctor blade may be left in place to function as a non-serrated doctor blade.

Preferably the serrated doctor blades 56 and 58 are formed from composite material and may remain in substantially continuous contact with the surface of a calender roll during operation without unacceptable damage to the surface of the roll. Use of the doctor blade on a near continuous basis ensures that abrasive contaminants are continuously removed from the surface of the roll.

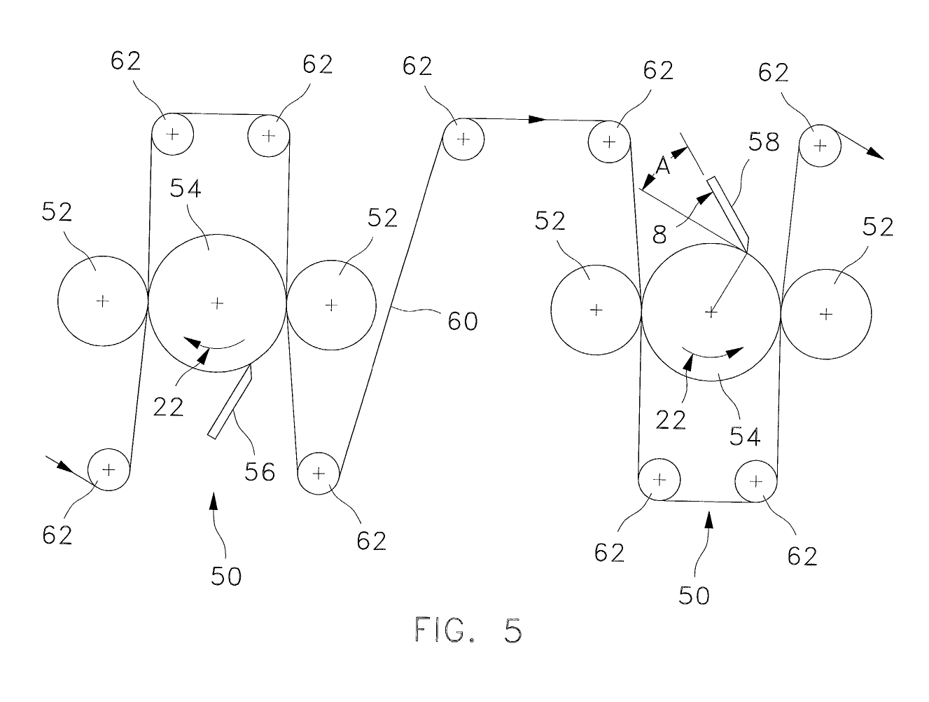

A portion of a typical dryer section of a papermachine or a coater is shown in FIG. 6, including dryer cans 100. Dryer cans 100 may be comprised of cast iron, chilled iron, ductile iron, forged steel or cast steel. The direction of rotation for each dryer can 100 is denoted by arrow 102. A paper web 112 is passed through the dryer cans 100, with the aid of dryer felt rolls 104. A dryer section felt 114 is typically used to aid in the removal of moisture from the paper web 112 by increasing the contact of the paper web with the dryer cans 100.

Advantageously one doctor blade 110 is positioned in a holder with its leading edge adjacent to the surface of each dryer can 100. Generally in the dryer section, doctor blades are applied against the surface of the dryer cans intermittently. When cleaning is desired, pressure is applied to the doctor blade holders, pressing the blades against the surface of the dryer can. When pressure is applied, the doctor blades are considered “loaded”. When deposits have been removed, the pressure is released and the doctor blades are moved away from the surface, i.e., the blades are “unloaded”.

The doctor blade 110 may be located anywhere on the circumference of the dryer can 100, provided that the leading edge 13 (FIG. 1) operates against the rotational direction of the metal roll, as shown in FIG. 6. Preferably, each doctor blade 110 is positioned after the paper web 112 has passed around the circumference of each dryer can 100. Such a location ensures that the doctor blade cleans the dryer can after one full pass of the paper web. Practitioners skilled in the art are aware of the most appropriate location for a doctor blade taking into account unique operational considerations, such as the process path of the paper web and instrumentation or other equipment in the vicinity of the roll to be doctored, safety considerations, and maintenance considerations.

The angle of the beveled surface and the operating angles of the doctor blades 110 are the same as discussed above with reference to FIG. 5.

When a machine upset occurs, e.g., a web break, causing significant deposits on the dryer rolls, any conventional non-serrated doctor blades, or worn serrated blades, are replaced with serrated doctor blades 110 which are then pressed against the surface of the dryer cans 100. Typically all doctor blades in the dryer section are loaded during an upset. Once the deposits have been removed, all doctor blades in the dryer section tend to be unloaded. It is generally preferable that the serrated doctor blades 110 are pressed intermittently against the surface of the dryer cans 100 (e.g., loaded and unloaded) as needed for subsequent cleaning activities.

As discussed above, the serrations wear away as the beveled surface wears away during the cleaning process and the doctor blade may be left in place to function as a non-serrated doctor blade.

The pressure of the doctor blade 110 against the dryer can 100 is typically about 130 to 350 N/m. Advantageously, serrated doctor blades 110 for the dryer section can be used routinely, in which case an immediate substitution in the event of an upset may not be necessary unless the serrations have worn away.

Advantageously the holders on which the doctor blades are mounted are capable of oscillation when holding the serrated doctor blades. Typically, doctor blades are oscillated in a cross-machine direction (FIG. 1, direction 20). Oscillation of the serrated doctor blade tends to improve the cleaning capability of the blade because, in some cases, without oscillation only circumferential bands of coating would be removed by the projections between the serrations, causing a corduroy effect in the deposits. Oscillation of serrated doctor blade promptly removes these bands. It is also believed that oscillation allows the side of a projection, i.e., the interface between a serration and a projection, to cut into a deposit in a cross machine direction. Thus the serrated doctor blade cleans the roll surface in two directions simultaneously.

Oscillation of the serrated doctor blade is also important in processes where damage to the roll surface may affect the final product attributes, such as calendering of paper. If a serrated doctor blade is not oscillated while it is pressed against the surface of a calendering roll, the projections between the serrations may damage the roll surface once the deposits have been removed. The damage appears in the form of circumferential rings on the roll surface, corresponding to the locations of the projections on the doctor blade. When such rings form on a calendering roll (roll 54 in FIG. 5) the resulting paper web 60 (FIG. 5) typically exhibits narrow bands of decreased paper gloss in areas corresponding to the rings. Oscillation prevents the occurrence of such rings on the roll surface. The length of oscillation movement is not generally limited as long as the doctor blade remains in contact with the roll surface over an area corresponding to the path of the paper web (web 60 in FIG. 5 and web 112 in FIG. 6). The length of oscillation movement in one direction typically ranges from about 15 to 230 mm.

FIG. 5 and FIG. 6 are for illustrative purposes and demonstrate two possible locations for the serrated doctor blades. Practitioners skilled in the art are aware that the configuration of dryer sections and calendering sections in papermachines vary. The serrated doctor blades are suitable for removing deposits on papermachine rolls wherever such rolls may be located and are not restricted for use only in the configurations shown in FIG. 5 and FIG. 6.

### EXAMPLE 1

Composite doctor blades commercially available from Essco, Inc. under the trade name ELI Fiberline were modified with an abrasive coating as described in U.S. Pat. No. 5,174,862 (Hale et al.). The dimensions of the doctor blades 10 were 767 mm long, 76 mm width and 2.8 mm thick. After application of the abrasive coating, a beveled surface 14, having an angle of 45°, was cut in the leading edge of each doctor blade. Referring to FIG. 2, a plurality of serrations 24 were created in the beveled surface of several composite doctor blades, with a serration depth 26 of 1.9 mm, a serration width 24 of 6.35 mm and serration spacing 42 of 12.7 mm

The modified (coated and beveled) doctor blades without serrations were used in both calender units on a commercial scale papermachine as shown in FIG. 5 on a substantially continuous basis. The pressure of the doctor blades against the metal rolls 54, which were coated with a thermal spray coating, was about 350 N/m and the operating angle was about 27°. During a web break, a serrated doctor blade was placed in the first calender unit, similar to the first unit 50 shown in FIG. 5. No process parameters were changed during the initial hours of operation of the serrated doctor blade.

At the time of the replacement, the metal roll 54 exhibited a light haze and the 75° gloss of the paper product was 68.5. The 75° gloss of the next roll of paper product (approximately one hour after the serrated doctor blade was inserted) was 70.9. The next roll of paper product, e.g., approximately one hour later, had a 75° gloss of 71.1. The serrations 24 had worn away within approximately 45 minutes of operation but the doctor blade was left in place to function as a conventional non-serrated doctor blade for 3 days. This length of time is considered an acceptable life for a doctor blade in use on a substantially continuous basis.

### EXAMPLE 2

Modified composite doctor blades were manufactured without and with serrations (Blades A and B respectively), as described in Example 1. A third composite doctor blade, Blade C, was formed from alternating reinforcement and unidirectional layers, as depicted in FIG. 4 where the outer layers and the core layer are formed from reinforcement layers. The reinforcement layers were formed from a fiberglass fabric, woven in a plain weave style, supplied by Essco, Inc. The unidirectional layers were formed from 1093 E-Glass Fabric, a fiberglass fabric including 95% by weight unidirectional fibers, available from Fibre Glast Developments Corporation. The impregnating resin was an epoxy resin with a Tg of about 180° C. The resin contained 13% by weight hollow glass microspheres having a particle size of about 60 μm. Blades A, B, C were each 305 mm long, 76 mm width and 2.8 mm thick.

Each blade was tested in a wear tester to determine effectiveness in removal of deposits. The wear tester consists of a laboratory scale calender roll having a thermal spray coating. The dimensions of the roll are 205 mm long with a diameter of 229 mm. The roll contains an internal electric heating element enabling the roll surface temperature to be adjusted up to about 205° C. The roll may be rotated at a speed of up to about 1,065 m/min. A doctor blade holder with a pneumatic oscillator is positioned on the tester such that an experimental doctor blade may be positioned against the roll surface and oscillated in a substantially cross-machine direction (FIG. 1, direction 20). The length of oscillation movement in one direction is about 25 mm.

To simulate deposits of coating material on a calendering roll, a coating containing mineral pigments and a styrene-butadiene latex with a starch co-binder was sprayed on the roll which was heated to a surface temperature of about 175° C. The coating dried on the roll surface to form a layer with a thickness ranging from 1.6 to 3.2 mm. The rotational speed of the roll was 940 m/min.

Each Blade A, B and C was positioned against the rotating roll having a dried coating layer. The blade pressure was 350 N/m. Because removal of the deposits occurs very quickly, each test was filmed so that the performance of the blades could be reviewed frame by frame. The film speed is 30 frames per second. Blades B and C contained serrations which immediately created a corduroy effect in the dried coating as circumferential bands of coating were removed by the projections between the serrations. These bands were subsequently removed with oscillation. The dried coating layer was completely removed by Blade B in 42 frames (1.4 seconds) and by Blade C in 46 frames (1.5 seconds). While Blade A without serrations rapidly removed most of the dried coating, a haze of coating material remained on the roll surface. The dried coating was completely removed by Blade A in 126 frames (4.2 seconds). This amount of difference in cleaning time would correspond to a significant difference in cleaning capability in a production environment.

Other embodiments are within the claims. For instance, the doctor blades of the invention are suitable for use in other web manufacturing industries which employ rolls, e.g., printing, polymer film, flooring, and textile. The use of doctor blades is known in a variety of industrial applications such as strip steel rolling and coating, food processing, chemical processing, and waste water treatment and sludge dewatering. Although the serrated doctor blades discussed above and shown in the drawings exhibit a beveled surface, in some applications it may not be necessary to use a beveled surface. Furthermore different geometries for the blade edge may be used. Although the serrations described above and shown in the drawings exhibit a hemispherical shape, other shapes may be used. It is also possible to use a mixture of serration shapes on a single doctor blade, e.g., some hemispherical and some rectangular. Although relief cuts have been shown only in the serrations, it may be possible in certain applications to place the relief cuts in the non-serrated portions of the doctor blade. Various modifications of this invention will become apparent to those skilled in the art without departing from the scope or spirit of this invention.

What is claimed is:

1. A doctor blade comprising a body having an elongated edge configured for application against a circumferential surface of a roll rotating upon a rotational axis, the edge defining a plurality of serrations.

2. The doctor blade of claim 1 wherein the body includes a beveled surface.

3. The doctor blade of claim 1 wherein at least some of the serrations have a hemispherical shape.

4. The doctor blade of claim 1 wherein at least some of the serrations have a depth of about 1.50 to 8.50 mm.

5. The doctor blade of claim 1 wherein the serrations have a depth not exceeding 25% of the width of the doctor blade.

6. The doctor blade of claim 5 wherein the depth of the serrations is about 10 to 15% of the width of the doctor blade.

7. The doctor blade of claim 4 wherein the depth of the serrations is non-uniform along the edge.

8. The doctor blade of claim 1 wherein the serrations have a width of about 6.35 to 14.30 mm.

9. The doctor blade of claim 1 wherein a summation of the widths of the serrations is about 30 to 60% of the length of the doctor blade.

10. The doctor blade of claim 9 wherein the summation of the widths of the serrations is about 40 to 50% of the length of the doctor blade.

11. The doctor blade of claim 1 wherein the serrations are positioned on the edge at a spacing of about 9.50 to 25.40 mm, as measured from a center of a serration to a center of an adjacent serration.

12. The doctor blade of claim 1 wherein the spacing of the serrations is non-uniform along the edge.

13. The doctor blade of claim 1 wherein the edge further defines a plurality of relief cuts.

14. The doctor blade of claim 13 wherein the relief cuts extend from a bottom surface of at least some of the serrations into the width of the doctor blade.

15. A doctor blade comprising a body having an elongated edge configured for application against a circumferential surface of a roll rotating upon a rotational axis, the edge defining a plurality of serrations and a plurality of relief cuts each extending from a bottom surface of at least some of the serrations into the width of the doctor blade.

16. The doctor blade of claim 15 wherein the relief cuts are formed in alternating serrations.

17. The doctor blade of claim 15 wherein a combined depth of a serration and a relief cut is about 15 to 30% of the width of the doctor blade.

18. A doctor blade comprising a body having an elongated edge configured for application against a circumferential surface of a roll rotating upon a rotational axis, the doctor blade comprising a composite material including a plurality of fibrous layers impregnated with a resin and the edge defining a plurality of serrations.

19. The doctor blade of claim 18 wherein the body includes a beveled surface.

20. The doctor blade of claim 18 wherein the composite material has a laminate structure comprising a plurality of unidirectional fibrous layers and a plurality of reinforcement fibrous layers.

21. The doctor blade of claim 18 wherein the resin is selected from the group consisting of thermoplastic resin and epoxy resin.

22. The doctor blade of claim 18 wherein the resin has a glass transition temperature of about 65 to 315° C.

23. The doctor blade of claim 18 wherein the resin further comprises an abrasive additive selected from the group consisting of glass microspheres, glass fibers, crushed glass, synthetic or industrial diamond particles, silica particles, silicon carbide particles, boron particles, zirconium particles, aluminum oxide particles and mixtures thereof.

24. A method of cleaning a circumferential surface of a roll rotating upon a rotational axis comprising the steps of:
a) positioning a doctor blade comprising a body having an elongated, serrated edge near the roll surface;
b) pressing the serrated edge of the doctor blade against the roll surface; and
c) simultaneously with the pressing step, oscillating the doctor blade a direction substantially parallel with the rotational axis of the roll.

25. The method of claim 24 wherein the body includes a beveled surface.

26. The method of claim 24 wherein the serrated doctor blade comprises a composite material having a laminate structure comprising a plurality of fibrous layers impregnated with a resin.

27. The method of claim 24 or 25 wherein the serrated edge of the doctor blade remains in contact with the rotating roll surface on an intermittent basis.

28. The method of claim 24 or 25 wherein the serrated edge of the doctor blade remains in substantially continuous contact with the rotating roll surface.

29. The method of claim 26 wherein the serrations of the serrated edge wear away during use, and the method further comprises leaving the blade edge in contact with the roll surface after the serrations have worn away.

30. A method of removing process contaminants from a circumferential surface of a rotating papermaking roll comprising the steps of:
a) positioning a doctor blade comprising a body having an elongated, serrated edge near the roll surface during a papermaking process; and
b) pressing the serrated edge of the doctor blade against the roll surface.

31. The method of claim 30 wherein the body includes a beveled surface.

32. The method of claim 30 or 31 wherein, simultaneously with the pressing step, the doctor blade is oscillated in a direction substantially parallel with the rotational axis of the roll.

33. The method of claim 32 wherein the serrated edge of the doctor blade remains in contact with the rotating roll surface on an intermittent basis.

34. The method of claim 32 wherein the serrated edge of the doctor blade remains in substantially continuous contact with the rotating roll surface.

35. The method of claim 30 wherein the pressing step is performed at a pressure of about 85 to 700 N/m.

36. The method of claim 35 wherein the pressing step is performed at a pressure of about 175 to 440 N/m.

37. The method of claim 30 wherein the serrated doctor blade comprises a composite material having a laminate structure comprising a plurality of fibrous layers impregnated with a resin.

38. The method of claim 37 wherein the resin has a glass transition temperature of about 65 to 315° C.

39. The method of claim 37 wherein the resin further comprises an abrasive additive selected from the group consisting of glass microspheres, glass fibers, crushed glass, synthetic or industrial diamond particles, silica particles, silicon carbide particles, boron particles, zirconium particles, aluminum oxide particles and mixtures thereof.

40. The method of claim 37 wherein the serrations of the serrated edge wear away during use, and the method further comprises leaving the blade edge in contact with the roll surface after the serrations have worn away.
